(19) United States
(12) Patent Application Publication
(10) Pub. No.: US 2002/0130086 A1
(43) Pub. Date: Sep. 19, 2002

(54) Process for treating sludge

(75) Inventor: Nobuyoshi Miura, Hidaka-city (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE SAITAMA LIVESTOCK FARM (SAIBOKU) CO., LTD., Hidaka-city (JP)

(21) Appl. No.: 10/067,308

(22) Filed: Feb. 7, 2002

(30) Foreign Application Priority Data
Feb. 8, 2001 (JP) 2001-32930
Jun. 18, 2001 (JP) 2001-184020

(51) Int. Cl. B03D 1/00

(52) U.S. Cl. 210/705

(57) ABSTRACT

A process for treating sludge is disclosed. Sludge to which a flocculating agent has been added is stirred by a stirring pump or shear-stirred by a liquid shear-stirrer prior to initiation of flocculation reaction of the flocculating agent to render the flocculating agent in a fine particulate state to thereby disperse, diffuse or distribute the flocculating agent in a fine particulate state throughout the sludge, so that flocks or aggregate structure type flocks or blocks can be efficiently formed. A treating line is constructed such that the sludge can flow therein as a laminar flow. The distance from a flocculating agent injection part to a stirring pump is made to a distance such that the flocculating agent can pass through in a reaction initiation time obtained in advance for the flocculating agent. The time at which flocculation strength of flocks formed by the flocculation reaction of the flocculating agent is maximal is experimentally confirmed in advance and a solid-liquid separator is set at a position where at such time the flocks can reside by the solid-liquid separator.

### BACKGROUND OF THE INVENTION

1. Field of the Invention

The present invention relates to a process for treating sludge, more particularly, to a process for purifying sludge from a clean water processing plant, a sewage treatment plant, a night soil treatment station, a farm community wastewater treatment plant, a stock raising wastewater treatment plant, various types of plant wastewater disposal plants and so forth.

2. Description of the Related Art

Processing of dissolved solids separated and removed from a target region for purification, raw sludge, and excess sludge produced from activated sludge process equipment has been heretofore performed. As illustrated in FIG. 10, a conventional processing of sludge is performed by removing, in a raw water tank 11, floating solid 12 contained in sludge by gravity sedimentation, supplying suspended solid and fine floating solid which are in supernatant 10 and cannot be readily removed by the gravity sedimentation only by use of a sludge supply pump 16 to a first flocculating and mixing tank 13, stirring them in the tank 13 together with a first flocculating agent supplied thereto (usually at about 300 rpm since high speed stirring is a cause of inhibition of flocculation), supplying the mixture to a second flocculating and mixing tank 17 over about 3 to 5 minutes, stirring it in the tank 17 together with a second flocculating agent supplied thereto to form flocks due to flocculation with the flocculating agent, sending them from the second flocculating and mixing tank 17 to a solid-liquid separator 14, and dehydrating the flocks by the solid-liquid separator 14 to separate them into a solid and a liquid, which are discharged separately. In this case, various apparatuses and flocculating agents have been developed in order to facilitate solid-liquid separation by the solid-liquid separator 14. Pipes used in this apparatus usually have an inner diameter of 50 mm (50 φ) and a flow rate of about 12 tons/hour (t/h).

The conventional process for treating sludge has the following problems.

(1) As shown in FIG. 10, the flocculating and mixing tank 13 for mixing with a flocculating agent must be installed between the raw water tank 11 and the solid-liquid separator 14, so that a place for installing it has to be secured and installation cost is also required.

(2) since the stirred suspended solid and fine floating solid must be retained in the flocculating and mixing tank 13 for a time necessary for the progress of flocculation reaction, sludge treatment takes much time.

(3) In order to prevent destruction of flocks formed in the flocculating and mixing tank 13, vigorous stirring cannot be performed in the flocculating and mixing tank 13. As a result, handling is cumbersome and in addition dispersion of a flocculating agent is not performed efficiently and only those flocks that are much water-swollen are obtained. Accordingly, water separation is low and dehydrated cake with a low water content cannot be obtained in the solid-liquid separator 14. Further, the use amount of the flocculating agent, production amount of dehydrated cake and use amount of a moisture controlling agent as a compost material are increased, which is uneconomical. Furthermore, performing the treatment for the moment is given priority, with the possibility of causing secondary pollution with respect to the quantity and quality of sludge being unsolved, thus failing to give a fundamental solution.

### SUMMARY OF THE INVENTION

An object of the present invention is to provide a process for treating sludge that can solve the above-mentioned problems by forming dense and less water-swollen flocks or aggregate structure type flocks.

The characteristics of the present invention is matching of the flocculating action with physical conditions exerted on the chemical reaction of a chemical thus far overlooked, that is distributing, dispersing or diffusing the flocculating agent in a state of fine particles throughout the target wastewater before the reaction of the flocculating agent, and adjusting the treating line in which the wastewater flows such that during the time from the initiation to the termination of the reaction the wastewater flows in a laminar flow. The present invention is also characterized in that a flocculating agent is dispersed, diffused or distributed throughout sludge before the flocculation reaction of the flocculating agent is initiated, and that the time at which flocculation strength of flocks formed by the flocculation reaction of the flocculating agent is maximum is experimentally confirmed in advance and the distances between the apparatuses are set such that the solid-liquid separator is set at a location where at such time the flocks can reside by the solid-liquid separator, thus giving flocculating effect and water separating effect better than ever, so that stabilization of running of the sludge processing equipment as a whole and simplification of handling and economical effect can be obtained.

According to a first aspect of the present invention, there is provided a process for treating sludge, characterized by comprising the steps of: adding to sludge and wastewater (hereinafter collectively referred to as “sludge”) flowing in a sludge treatment line a flocculating agent for flocculating various materials such as dissolved solid, suspended solid or fine floating solid in the sludge in the midway of the sludge treatment line; and stirring the flocculating agent-added sludge by a stirring pump arranged in the midway of sludge treatment line prior to initiation of flocculation reaction of the flocculating agent to disperse, diffuse or distribute the flocculating agent in a fine particulate state throughout the sludge in the sludge treatment line, thus forming flocks as a result of the flocculation reaction of the flocculating agent.

According to a second aspect of the present invention, there is provided a process for treating sludge, characterized by comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; stirring the flocculating agent-added sludge by a stirring pump arranged in the midway of sludge treatment line prior to initiation of flocculation reaction of the flocculating agent to disperse, diffuse or distribute the flocculating agent in a fine particulate state throughout the sludge in the sludge treatment line, and then adding to the sludge a second flocculating agent at a second flocculating agent injection part in the midway of the sludge treatment line to form flocks as a result of the flocculation reaction of the flocculating agent.

According to a third aspect of the present invention, there is provided a process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; shear-stirring the flocculating agent-added sludge by a stirring pump arranged in the midway of sludge treatment line prior to initiation of flocculation reaction of the flocculating agent to disperse, diffuse or distribute the flocculating agent in a fine particulate state throughout the sludge in the sludge treatment line to form flocks by flocculation reaction, then adding to the sludge a second flocculating agent at a second flocculating agent injection part in the midway of the sludge treatment line; and then stirring the flocculating agent-added sludge by a second stirring pump arranged in the midway of sludge treatment line prior to initiation of flocculation reaction of the flocculating agent such that the flocks thereof are not destructed to disperse, diffuse or distribute the flocculating agent in a fine particulate state throughout the sludge in the sludge treatment line to form flocks as a result of the flocculation reaction of the flocculating agent.

According to a forth aspect of the present invention, there is provided a process for treating sludge, characterized by comprising the steps of: adding to sludge flowing in a sludge treatment line flocculating agent for flocculating various materials such as dissolved solid, suspended solid or fine floating solid in the sludge at two or more flocculating agent injection parts in the midway of the sludge treatment line; and stirring the flocculating agent-added sludge by a stirring pump or stirring pumps arranged in the midway of sludge treatment line and ahead of arbitrary flocculating agent injection part or parts prior to initiation of flocculation reaction of the flocculating agent to disperse, diffuse or distribute the flocculating agent in a fine particulate state throughout the sludge in the sludge treatment line, thus forming flocks as a result of the flocculation reaction of the flocculating agent.

According to a fifth aspect of the present invention, in the process for treating sludge according to any one of the first to fourth aspects of the invention, the flocks formed in the sludge treatment line are separated into a solid and liquid in a solid-liquid separator.

According to a sixth aspect of the present invention, in the process for treating sludge according to any one of the first to fifth aspects of the invention, the sludge flowing in the sludge treatment line downstream of the stirring pump is made a laminar flow to prevent destruction of the flocks formed in the sludge treatment line.

According to a seventh aspect of the present invention, in the process for treating sludge according to any one of the first to sixth aspects of the invention, the distance from the flocculating agent injection part to the stirring pump is set to a distance such that the flocculating agent can pass through in a reaction initiation time obtained in advance for each flocculating agent.

According to an eighth aspect of the present invention, in the process for treating sludge according to any one of the second to seventh aspects of the invention, either or both of the distances from the stirring pump to the flocculating agent injection part ahead thereof and the distance from the stirring pump to the solid-liquid separator is or are set to a distance or distances up to positions such that the flocculation strengths of flocks calculated based on the flocculation lasting periods of time of flocks formed after the stirring by the stirring pump are maximum.

According to a ninth aspect of the present invention, there is provided a process for treating sludge, comprising the steps of: adding to sludge flowing in a sludge treatment line a flocculating agent for flocculating various materials such as dissolved solid, suspended solid or fine floating solid in the sludge in the midway of the sludge treatment line; and shear-stirring the flocculating agent-added sludge by a liquid shear-stirrer arranged in the midway of the sludge treatment line prior to initiation of flocculation reaction of the flocculating agent to disperse, diffuse or distribute the flocculating agent in a fine particulate state throughout the sludge in the sludge treatment line, thus forming aggregate structure type flocks as a result of the flocculation reaction of the flocculating agent.

According to a tenth aspect of the present invention, there is provided a process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; shear-stirring the flocculating agent-added sludge by a liquid shear-stirrer arranged in the midway of sludge treatment line prior to initiation of flocculation reaction of the flocculating agent to disperse, diffuse or distribute the flocculating agent in a fine particulate state throughout the sludge in the sludge treatment line; and then adding to the sludge a second flocculating agent at a second flocculating agent injection part in the midway of the sludge treatment line to form aggregate structure type flocks as a result of the flocculation reaction of the flocculating agent.

According to an eleventh aspect of the present invention, there is provided a process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; shear-stirring the flocculating agent-added sludge by a first liquid shear-stirrer arranged in the midway of sludge treatment line prior to initiation of flocculation reaction of the flocculating agent to disperse, diffuse or distribute the flocculating agent in a fine particulate state throughout the sludge in the sludge treatment line to form particle flocks by flocculation reaction; then adding to the sludge a second flocculating agent at a second flocculating agent injection part in the midway of the sludge treatment line; then shear-stirring the flocculating agent-added sludge by a second liquid shear-stirrer arranged in the midway of sludge treatment line prior to initiation of flocculation reaction of the flocculating agent such that the particle flocks are not destructed to disperse, diffuse or distribute the flocculating agent in a fine particulate state throughout the sludge in the sludge treatment line to form aggregate structure type flocks as a result of the flocculation reaction of the flocculating agent; and allowing aggregate structure type flocks to gather at a subsequent laminar flow stage to grow into a sludge block.

According to a twelfth aspect of the present invention, there is provided a process for treating sludge, comprising the steps of: adding to sludge flowing in a sludge treatment line a flocculating agent for flocculating various materials such as dissolved solid, suspended solid or fine floating solid in the sludge at two or more flocculating agent injection parts in the midway of the sludge treatment line; and stirring the flocculating agent-added sludge by a liquid shear-stirrer or liquid shear-stirrers arranged in the midway of sludge treatment line and ahead of arbitrary flocculating agent injection part or parts prior to initiation of flocculation reaction of the flocculating agent to disperse, diffuse or distribute the flocculating agent in a fine particulate state throughout the sludge in the sludge treatment line, thus forming flocks as a result of the flocculation reaction of the flocculating agent.

According to a thirteenth aspect of the present invention, in the process for treating sludge according to any one of ninth to twelfth aspect of the invention, the aggregate structure type flocks formed in the sludge treatment line are separated into a solid and liquid in a solid-liquid separator.

According to a fourteenth aspect of the present invention, in the process for treating sludge according to any one of the ninth to thirteenth aspects of the invention, the sludge flowing in the sludge treatment line downstream of the liquid shear-stirrer is made a laminar flow to prevent destruction of the aggregate structure type flocks formed in the sludge treatment line.

According to a fifteenth aspect of the present invention, in the process for treating sludge according to any one of ninth to fourteenth aspect of the invention, the distance between the flocculating agent injection part to the liquid shear-stirrer is set to a distance such that the flocculating agent can pass through in a reaction initiation time obtained in advance for each flocculating agent.

According to a sixteenth aspect of the present invention, in the process for treating sludge according to any one of the ninth to fifteenth aspects of the invention, either or both of the distances from the first liquid shear-stirrer to the second flocculating agent injection part and the distance form the second flocculating agent injection part to the second liquid shear-stirrer is or are set to a distance or distances up to positions such that the flocculation strengths of flocks calculated based on the flocculation lasting periods of time of flocks formed after the shear-stirring by the second liquid shear-stirrer (21) are maximum.

### BRIEF DESCRIPTION OF THE DRAWINGS

In the accompanying drawings:

FIG. 1 is a diagram illustrating Embodiment 1 of the present invention;

FIG. 2 is a diagram illustrating Embodiment 2 of the present invention;

FIG. 3 is a diagram illustrating Embodiment 3 of the present invention;

FIG. 4 is a diagram illustrating Embodiment 4 of the present invention;

FIG. 5 is a diagram illustrating Embodiment 5 of the present invention;

FIG. 6 is a diagram illustrating Embodiment 6 of the present invention;

FIG. 7 is a diagram illustrating Embodiment 7 of the present invention;

FIGS. 8A and 8B are a diagram illustrating Embodiment 8 of the present invention;

FIG. 9 is a diagram illustrating a process for forming a flock, a flock of aggregate structure, and a block in the present invention; and

FIG. 10 is a diagram illustrating a conventional treating apparatus.

### DETAILED DESCRIPTION

Embodiments 1 to 3 of the process for treating sludge according to the present invention relate to a process in which a flocculating agent is added to raw sludge separated and removed from target wastewater purification region and excess sludge removed from activated sludge apparatus and the sludge is stirred by a stirring pump to disperse, diffuse or distribute the flocculating agent throughout the sludge, thus flocculating the sludge with the flocculating agent in a conditioned manner to form flocks, so that solid-liquid separation by a dehydrator can be facilitated.

Embodiments 4 to 6 of the process for treating sludge according to the present invention relate to a process in which using a liquid shear-stirrer in place of the above-mentioned stirring pump, sludge to which a flocculating agent has been added is shear-stirred with the liquid shear-stirrer to disperse, diffuse or distribute the flocculating agent throughout the sludge, thus flocculating the sludge with the flocculating agent in a conditioned manner to form dense and less water-swollen, aggregate structure type flocks (that presumably are constituted to have the same particulate structure as that of the aggregate structure of soil) so that solid-liquid separation by a dehydrator can be facilitated.

### Embodiment 1

As shown in FIG. 1, Embodiment 1 relates to the case where a flocculating agent is injected to a sludge treatment line 1 at two points. In FIG. 1, a pipe such as a vinyl chloride pipe or a VSC hose connects between a raw water tank 7 and a sludge supply pump 6, between the sludge supply pump 6 and a stirring pump 2, and between the stirring pump 2 and a solid-liquid separator 5 to construct a sludge treatment line 1. As the pipe, a pipe made of a material other than the resin, such as a metal-made pipe, may be used. The inner diameter of the pipe may vary depending on the utility; for example, a pipe having an inner diameter of 80 mm (80 φ) and ensuring a flow rate of about 20 t/h may be used.

In Embodiment 1 shown in FIG. 1, sewage, night soil, farm community waste water, stock raising waste water, and various types of plant waste waters and the like (these being called collectively as “sludge”) are pooled in the raw water tank 7, in which solids 9 having large particle sizes, such as stones, concrete debris, metal pieces, and wood pieces are precipitated by gravity sedimentation. Supernatant 8 of the sludge settled by gravity in the raw water tank 7 is introduced into the sludge treatment line 1 by the sludge supply pump 6. The flocculating agent is injected at a first flocculating agent injection part 3 and a second flocculating agent injection part 4.

As the flocculating agent, a cationic flocculating agent (acidic, for example, poly(iron chloride), etc.), an anionic flocculating agent (alkaline), a nonionic flocculating agent, and an amphoteric flocculating agent may be used. The flocculating agent is used after dissolving it in a solution and supplied to the sludge treatment line 1 by a liquid injecting pump. In the case where the flocculating agent to be used, for example, a cationic flocculating agent (acidic) for adsorbing components having negative charge in the sludge, is injected at the first flocculating agent injection part 3, an anionic flocculating agent (alkaline) for adsorbing components having positive charge in the sludge is injected at the second flocculating agent injection part 4. In the present invention, the anionic flocculating agent (alkaline) may be injected at the first flocculating agent injection part 3 and the cationic flocculating agent (acidic) may be injected at the second flocculating agent injection part 4.

Injection of the flocculating agent initiates flocculation reaction in the sludge treatment line 1. In the present invention, before the flocculation reaction is initiated, the sludge to which the flocculating agent has been added is stirred by the stirring pump 2 to make the sludge and flocculating agent in a fine particulate state, so that the flocculating agent can be dispersed, diffused or distributed throughout the sludge. The distance between the position where the flocculating agent is added to the position where the flocculation reaction is initiated may vary depending on the kind of flocculating agent and flow rate of sludge and therefore, the distance from the first flocculating agent injection part 3 to the installing position of the stirring pump 2 is suitably set to a distance calculated based on a flocculation reaction initiation time obtained by checking in advance for each flocculating agent. From experience, this distance is about 0.2 to 0.6 M.

As the stirring pump 2, a pump that is hardly clogged is suitable. For example, a centrifugal pump, a turbine pump, etc. are suitably used. The flocculating agent stirred by the stirring pump 2 and dispersed, diffused or distributed throughout the sludge in a fine particulate state flocculates suspended solid and fine floating solid in the sludge to form flocks in the sludge treatment line 1. The number of rotations of the stirring pump 2 may vary depending on the material to be treated but is desirably selected from the range of about 200 to 2,000 rpm.

In the present invention, in order for flocks formed in the sludge treatment line 1 after the stirring by the stirring pump 2 not to be destructed during their flow in the sludge treatment line 1, the pipe is arranged and the stirring pump 2 is positioned such that the sludge flowing in the sludge treatment line 1 is not a turbulent flow but is a laminar flow. For this purpose, the pipe is arranged in a straight line or with a gentle curve, or without steps. The distance from the stirring pump 2 to the second flocculating agent injection part 4 and the distance form the second flocculating agent injection part 4 to the solid-liquid separator 5 are set to distances calculated based on the reaction time in which the strength of flocks is maximum, which is based on the flocculation lasting time of flocks. From experience, this distance is about 0.2 to 0.6 m.

The solid component (dehydrated cake) separated from the solid-liquid separator 5 and liquid component are separately sent to subsequent steps. For example, the dehydrated cake is sent to a step for compost and the liquid component is sent to a step for microorganism treatment.

### Embodiment 2

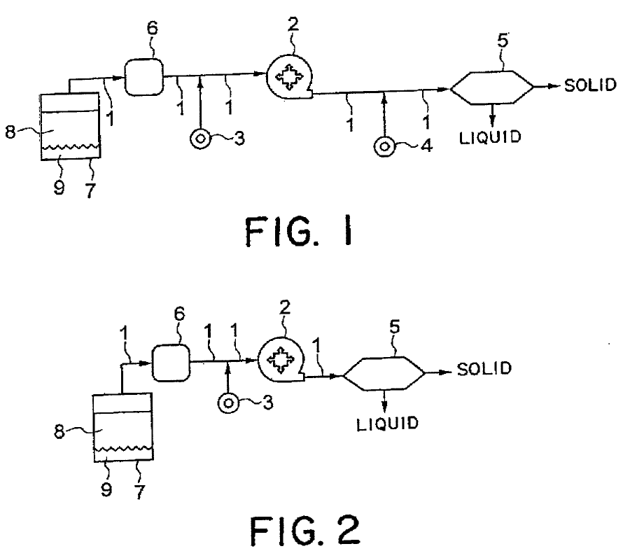

The process for treating sludge in accordance with Embodiment 2 of the present invention is illustrated with reference to FIG. 2. In Embodiment 2, a flocculating agent is added by injection at one point (flocculating agent injection part) 3 in the sludge treatment line 1. In this case, as the flocculating agent, a cationic flocculating agent (acidic, for example, poly (iron chloride), etc.) an anionic flocculating agent (alkaline), a nonionic flocculating agent, and an amphoteric flocculating agent may be used singly or in combination of two or more of them.

Also in the case illustrated in FIG. 2, addition of the flocculating agent initiates flocculation reaction in the sludge treatment line 1. In Embodiment 2 as well, before the flocculation reaction due to the flocculating agent is initiated, the sludge to which the flocculating agent has been added is stirred by the stirring pump 2 to make the sludge and flocculating agent in a fine particulate state, so that the flocculating agent can be dispersed, diffused or distributed throughout the sludge. This results in that the flocculating agent flocculates suspended solid and fine floating solid in the sludge to form flocks in the sludge treatment line 1.

The distance between the position where the flocculating agent is added and the position where the flocculation reaction is initiated as shown in FIG. 2 may vary depending on the kind of flocculating agent and flow rate of sludge. Therefore, the distance from the first flocculating agent injection part 3 to the installing position of the stirring pump 2 is set to a distance calculated based on a flocculation reaction initiation time obtained by checking in advance for each flocculating agent.

Also in FIG. 2, in order for flocks formed in the sludge treatment line 1 not to be destructed during their flow in the sludge treatment line 1, the supply pipe is arranged and the stirring pump is positioned such that the sludge flowing in the sludge treatment line 1 is not a turbulent flow but is a laminar flow. The flocks are separated by the solid-liquid separator 5 and the separated solid component (dehydrated cake) and liquid component are separately sent to subsequent steps in the same manner as in the case illustrated in FIG. 1.

### Embodiment 3

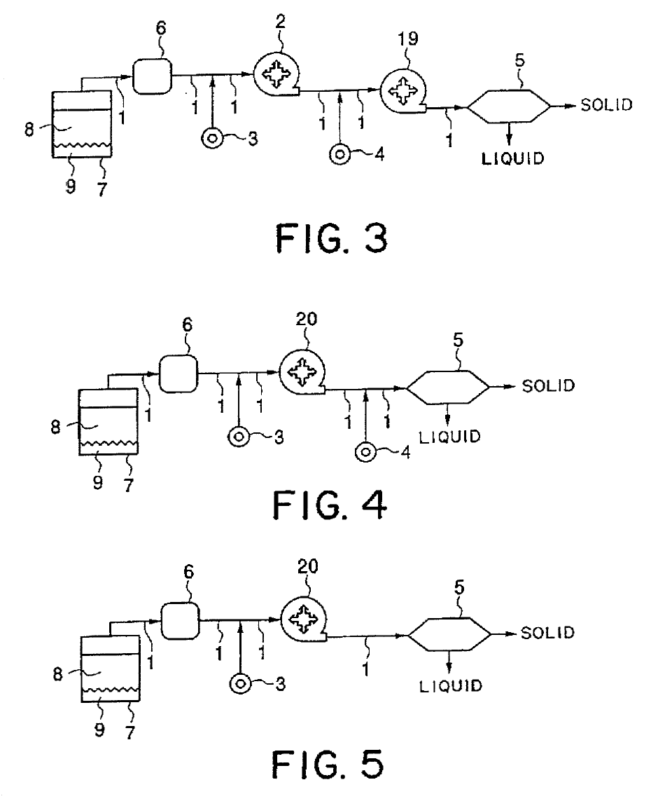

The process for treating sludge in accordance with Embodiment 3 of the present invention is illustrated with reference to FIG. 3. In Embodiment 3, a second stirring pump 19 is provided between the second flocculating agent injection part 4 and the solid-liquid separator 5 in the sludge treatment line 1 shown in FIG. 1. As the second stirring pump 19 of FIG. 3, the same pump as the first stirring pump 2 shown in FIG. 2 may be used. The number of rotations may vary depending on the material to be treated, but is desirably selected in the rage of about 200 to 2,000 rpm.

In Embodiment 3 illustrated in FIG. 3, the action up to the one before the second stirring pump 19 is the same as in Embodiment 1 illustrated in FIG. 1. The difference between Embodiment 3 and Embodiment 1 illustrated in FIG. 3 and FIG. 1 is that the sludge after injection of the second flocculating agent is stirred by the second stirring pump 19 to disperse, diffuse or distribute the flocculating agent throughout the sludge in a fine particulate state. In this case as well, before flocculation reaction due to the second flocculating agent is initiated, the sludge is stirred by the second stirring pump 19. This results in that the flocculating agent which is dispersed, diffused or distributed throughout the sludge flocculates suspended solid and fine floating solid in the sludge to form flocks in the sludge treatment line 1. The flocks are separated by the solid-liquid separator 5 into solid and liquid and the solid component (dehydrated cake) and liquid component are separately sent to subsequent steps. For example, the dehydrated cake is sent to a step for compost and the liquid component is sent to a step for microorganism treatment.

Also in FIG. 3, in order for flocks formed in the sludge treatment line 1 after the stir by the stirring pump 2 not to be destructed during their flow in the sludge treatment line 1, the pipe is arranged and the stirring pumps 2 and 19 are positioned such that the sludge flowing in the sludge treatment line 1 is not a turbulent flow but is a laminar flow.

The distance between the position where the second flocculating agent is added and the position where the flocculation reaction due to the flocculating agent is initiated as shown in FIG. 3 may vary depending on the kind of flocculating agent and flow rate of sludge. Therefore, in the case of FIG. 3 as well, the distance from the second flocculating agent injection part 4 to the installing position of the second stirring pump 19 is set to a distance calculated based on a flocculation reaction initiation time obtained by checking in advance for each flocculating agent. From experience, this distance is about 0.2 to 0.6 m.

### Embodiment 4

The process for treating sludge in accordance with Embodiment 4 of the present invention is illustrated with reference to FIG. 4. In the process for treating sludge illustrated in FIG. 4, the stirring pump 2 in the sludge treatment line 1 shown in FIG. 1 is replaced by a liquid shear-stirrer 20.

### Embodiment 5

The process for treating sludge in accordance with Embodiment 5 of the present invention is illustrated with reference to FIG. 5. In the process for treating sludge illustrated in FIG. 5, the stirring pump 2 in the sludge treatment line 1 shown in FIG. 2 is replaced by a liquid shear-stirrer 20.

### Embodiment 6

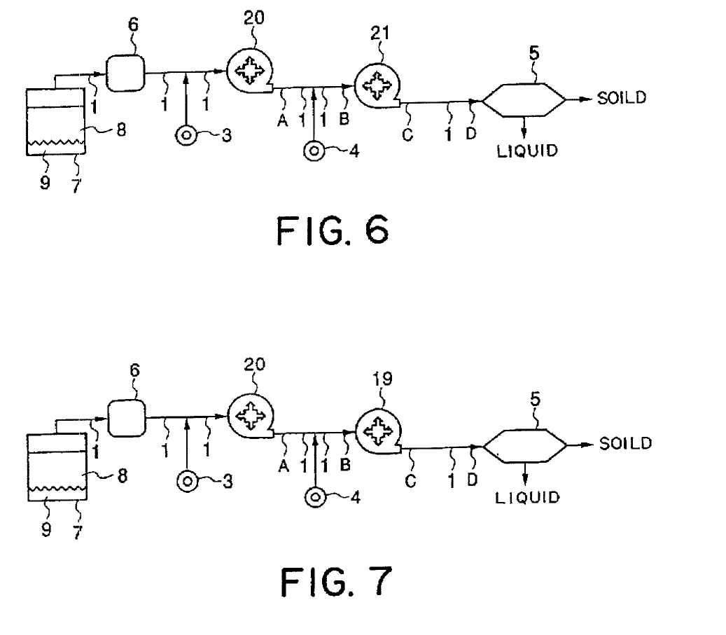

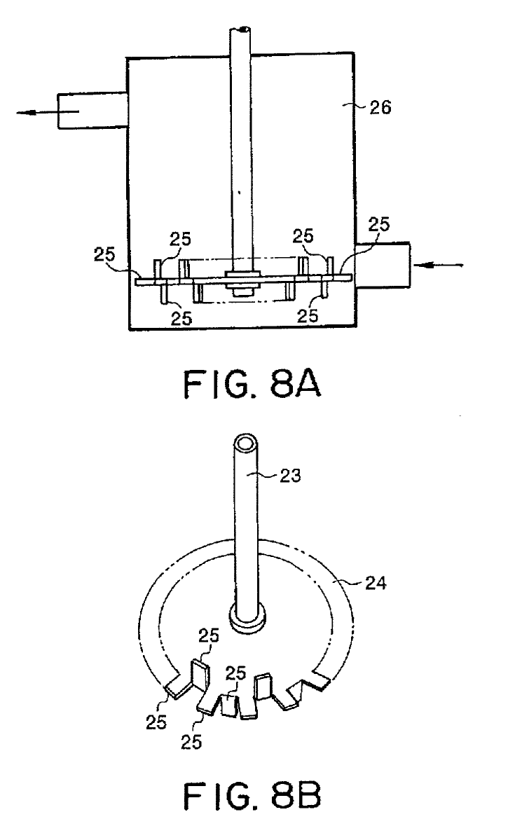

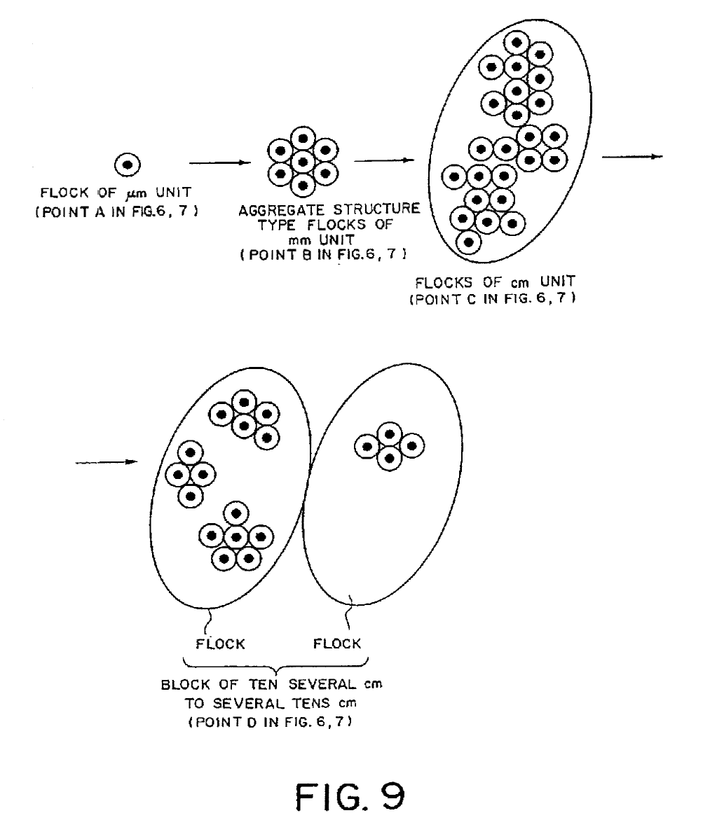

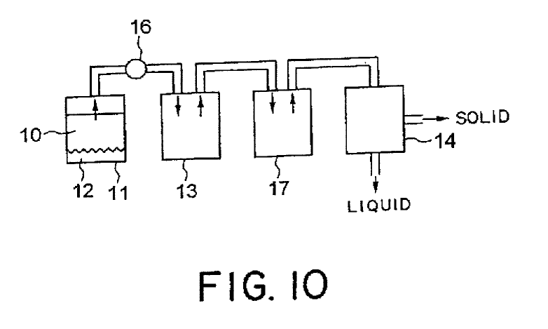

The process for treating sludge in accordance with Embodiment 6 of the present invention is illustrated with reference to FIG. 6. In the process for treating sludge illustrated in FIG. 6, the two stirring pumps 2 and 19 in the sludge treatment line 1 in FIG. 3 are replaced by two liquid shear-stirrers 20 and 21, respectively.

### Embodiment 7

The process for treating sludge in accordance with Embodiment 7 of the present invention is illustrated with reference to FIG. 7. In the process for treating sludge illustrated in FIG. 7, the first stirring pump 2 in the sludge treatment line 1 shown in FIG. 3 is replaced by a first liquid shear-stirrer 20, thus using the liquid shear-stirrer 20 and the stirring pump 19 in combination with each other.

The liquid shear-stirrers 20 and 21 in Embodiments 4 to 7 are suitably those that are hardly clogged. For example, the one having the structure illustrated in FIG. 8B, and those having other structure or mechanism may be used. The liquid shear-stirrer shown in FIG. 8B has a rotating shaft 23 having a disk 24 attached thereto and provided with a series of vanes 25, alternately formed directed upwardly, horizontally and downwardly over the entire outer periphery thereof. One example of the size of the liquid shear-stirrer in the case of a shear-stirring tank 26 having a height of 400 to 5,000 mm and a diameter of 200 mm is suitably such that the disk 24 has a diameter on the order of 100 to 150 mm, the vane 25 has a length on the order of 10 to 20 mm and a width on the order of 10 mm. The number of rotations of the liquid shear-stirrer may vary depending on the material to be treated, type of the machine, kind of flocculating agent and the like but is preferably selected from the range on the order of 200 to 2,000 rpm, and more preferably in the range of 1,000 to 1,800 rpm.

The basic action of Embodiment 4 is the same as the action of Embodiment 1, the basic action of Embodiment 5 is the same as the action of Embodiment 2, and the basic actions of Embodiments 6 and 7 are the same as the addition of Embodiment 3. The difference is that the sludge to which the flocculating agent has been added is shear-stirred by use of a liquid shear-stirrer instead of a stirring pump, and this makes the sludge and flocculating agent in a fine particulate state, so that the flocculating agent can be dispersed, diffused or distributed throughout the sludge. This results in that the flocculating agent flocculates dissolved solid, suspended solid and fine floating solid in the sludge to form flocks of aggregate structure type in the sludge treatment line 1. The flocks of aggregate structure type are separated into solid and liquid by the solid-liquid separator 5 in the sludge treatment line 1. The flocculating agent which is used in Embodiment 7 may be the same as the flocculating agent used in Embodiments 1 to 6. In FIGS. 6 and 7, the liquid shear-stirrers are arranged in two stages and by shear-stirring by use of the liquid shear-stirrer 20 in the former stage, sludge 31 adheres around fine particulates of flocculating agent 30 at the point A in FIGS. 6, 7 to form flocks having a size of μm unit (FIG. 9), which are further shear-stirred by the liquid shear-stirrer 21 in the latter stage so that at point B in FIGS. 6, 7, the flocks gather to form aggregate structure type flocks of 1 to 2 mm in size (FIG. 9). Then, between the liquid shear-stirrer 21 in the latter stage and the solid-liquid separator 5 (point C in FIGS. 6, 7), the aggregate structure of the aggregate structure type flocks is established and many such aggregate structure type flocks gather to form blocks of several centimeters (cm) to several tens centimeters (cm) in size (FIG. 9) at point D in FIGS. 6, 7.

In Embodiments 4 to 7 illustrated in FIGS. 4 to 7 as well, in order for flocks formed in the sludge treatment line 1 after the shear-stirring by the liquid shear-stirrers 20 and 21 not to be destructed during their flow in the sludge treatment line 1, adjustment is made such that the sludge flowing in the sludge treatment line 1 is not a turbulent flow but is a laminar flow as in Embodiment 1 illustrated in FIG. 1. To achieve a laminar flow, the flow rate of the sludge flowing in the sludge treatment line 1 is suitably 1 m/s or less, preferably 0.2 to 0.5 m/s.

In Embodiments 5 to 7 illustrated in FIGS. 5 to 7 as well, the distance from the first flocculating agent injection part 3 to the first liquid shear-stirrer 20, the distance from the second flocculating agent injection part 4 to the second liquid shear-stirrer 21, and the distance from the second liquid shear-stirrer 21 to the solid-liquid separator 5 may vary depending on the kind of the flocculating agent, the quality, quantity of flow and flow rate of sludge. For this reason, as in the case of Embodiment 1 illustrated in FIG. 1, the distances are set to distances such that the flocculating agent can pass through the apparatuses in a reaction initiation time obtained in advance for each flocculating agent; from experience, this distance is about 0.2 to 0.6 m.

Also, in Embodiments 5 to 7 illustrated in FIGS. 5 to 7, the distance from the first liquid shear-stirrer 20 to the second flocculating agent injection part 4, the distance from the second flocculating agent injection part 4 to the second liquid shear-stirrer 21 and the distance from the second liquid shear-stirrer 21 to the solid-liquid separator 5 are set to distances up to positions such that the flocculation strengths of flocks calculated based on the flocculation lasting periods of time of flocks formed after the shear-stirring by the first liquid shear-stirrer 20 and aggregate structure type flocks formed after the shearing by the second liquid shear-stirrer 21 are maximum, as the same as disclosed in Embodiments 1 to 3. From experience, these distances are suitably 1 to 10 m, preferably about 3 to 7 m. In the case where the distance of the above-mentioned section is 1 to 10 m and the flow rate of the sludge flowing in the sludge treatment line 1 is 1 m/s, the residence time of the sludge in the above-mentioned section is 10 to 60 seconds, preferably about 15 to 30 seconds.

### Industrial Availability

Of the processes for treating sludge of the present invention, the processes for treating sludge using a stirring pump as described in claims 1 to 8 have various effects as follows.

(1) Since a flocculating agent is dispersed, distributed or diffused in a fine particulate state throughout the sludge before the flocculation reaction of the flocculating agent is initiated, flocks that are dense, have strong cohesive force, and are hard and less water-swollen can be formed so that they are separated from water efficiently by the solid-liquid separator so that they can provide hydrated cake which is lower (by about 5 to 10%) in moisture content than that of the conventional dehydrated cake, thus decreasing the amount of dehydrate cakes produced. Since the dehydrated cake has a low moisture content, the moisture controlling agent for preparing compost material can be saved so that the process of the present invention is economical.

(2) Since two types of flocculating agents i.e., a cationic flocculating agent for adsorbing components having negative charge and an anionic flocculating agent for adsorbing components having positive charge are used, the components having negative or positive charge in the sludge can be adsorbed to form flocks.

(3) Since the flocculating agent is dispersed, distributed or diffused in a fine particulate state, the flocculation reaction is efficiently performed to save the flocculating agent and the process is economical.

(4) Since a stirring ramp is used, a large scale stirrer (flocculating and mixing tank) as a conventional one is no longer necessary, so that the apparatus can be miniaturized and simplified, its handling is easier and place where the apparatus is installed can be small. In addition, running and maintenance costs area reduced, which is economical.

(5) Since a large scale stirrer (flocculating and mixing tank) is unnecessary, a series of treatments can be continuously performed in the treating line, so that sludge can be efficiently and speedily treated. Further, the treating line can be designed to be linear or with a gentle curve, if curved, which makes it easier to construct a treating line suitable for achieving a laminar flow.

(6) Since flocks are separated into a solid component and a liquid component by use of a solid-liquid separator, the subsequent treatments can be performed with ease.

(7) Since the distance from the first flocculating agent injection part to the stirring pump is set to a distance such that the flocculating agent can pass through the apparatuses in a reaction initiation time obtained in advance for each flocculating agent, the flocculating agent can be dispersed, distributed or diffused in a fine particulate state throughout the sludge before the flocculation reaction of the flocculating agent is initiated.

(8) Since either or both of the distance from the stirring pump to the second flocculating agent injection part and the distance from the stirring pump to the solid-liquid separator are set to a distance or distances up to positions such that the flocculation strengths of flocks calculated based on the flocculation lasting periods of time of flocks formed after the stirring by the stirring pump are maximum, the flocks can be sent in a dense state to the solid-liquid separator, so that dehydrated cakes having a lower moisture content can be obtained.

Of the processes for treating sludge of the present invention, the processes for treating sludge using a liquid shear-stirrer as described in claims 9 to 16 have besides the effects as described above, various effects as follows.

(1) By shear-stirring by use of a liquid shear-stirrer, the flocculating agent can be dispersed, diffused or distributed in a fine particulate state, so that flocculation reaction can be efficiently performed to save the flocculating agent (20 to 50% reduction), which is economical.

(2) Since the liquid shear-stirrer is an atomizing apparatus which is simple in construction, efficient and economical, the sludge treating equipment as a whole is made simple, miniaturized, and easy in handling and requires only a small space for installment. In addition, it shows good stirring efficiency and incurs less running and maintenance costs, which is economically suitable.

(3) Since the flocculating agent is rendered in a fine particulate state by the liquid shearing type stirrer and uniformly diffused throughout the sludge and broad dispersion is performed such that the fine particulates are distributed in every portions, the efficiency of flocculation is high, and saving of the use amount of the flocculating agent, reduction in the production amount of dehydrated cake, and saving of the moisture controlling agent used as a raw material of compost can be achieved. Furthermore, loss of unreacted flocculating agent to the treating plant is minimized so that the entire water area can be biologically activated as a site for purification so that the process of the present invention is most suitable for environment protection.

(4) Since shear-stirring is performed by use of a liquid shear-stirrer, aggregate structure type flocks that are denser hard and less water-swollen can be formed. As a result, dehydrated cakes that show high water separating property, high dehydration rate by use of a hydroextractor and low water content can be obtained. From the experiments, the water content of dehydrated cakes is in the range of 68 to 75%, which indicates that a reduction in water content of about 5 to 8% as compared with products produced by competitors.

What is claimed is:

1. A process for treating sludge, comprising the steps of: adding to sludge flowing in a sludge treatment line a flocculating agent for flocculating various materials such as dissolved solid, suspended solid or fine floating solid in the sludge in the midway of the sludge treatment line; and stirring the flocculating agent-added sludge by a stirring pump arranged in the midway of sludge treatment line prior to initiation of flocculation reaction of the flocculating agent to disperse, diffuse or distribute the flocculating agent in a fine particulate state throughout the sludge in the sludge treatment line, thus forming flocks as a result of the flocculation reaction of the flocculating agent.

2. A process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; stirring the flocculating agent-added sludge by a stirring pump arranged in the midway of sludge treatment line prior to initiation of flocculation reaction of the flocculating agent to disperse, diffuse or distribute the flocculating agent in a fine particulate state throughout the sludge in the sludge treatment line; and then adding to the sludge a second flocculating agent at a second flocculating agent injection part in the midway of the sludge treatment line to form flocks as a result of the flocculation reaction of the flocculating agent.

3. A process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; shear-stirring the flocculating agent-added sludge by a stirring pump arranged in the midway of sludge treatment line prior to initiation of flocculation reaction of the flocculating agent to disperse, diffuse or distribute the flocculating agent in a fine particulate state throughout the sludge in the sludge treatment line to form flocks by flocculation reaction; then adding to the sludge a second flocculating agent at a second flocculating agent injection part in the midway of the sludge treatment line; and then stirring the flocculating agent-added sludge by a second stirring pump arranged in the midway of sludge treatment line prior to initiation of flocculation reaction of the flocculating agent such that the flocks thereof are not destructed to disperse, diffuse or distribute the flocculating agent in a fine particulate state throughout the sludge in the sludge treatment line to form flocks as a result of the flocculation reaction of the flocculating agent.

4. A process for treating sludge, comprising the steps of: adding to sludge flowing in a sludge treatment line flocculating agent for flocculating various materials such as dissolved solid, suspended solid or fine floating solid in the sludge at two or more flocculating agent injection parts in the midway of the sludge treatment line; and stirring the flocculating agent-added sludge by a stirring pump or pumps arranged in the midway of sludge treatment line and ahead of arbitrary flocculating agent injection part or parts prior to initiation of flocculation reaction of the flocculating agent to disperse, diffuse or distribute the flocculating agent in a fine particulate state throughout the sludge in the sludge treatment line, thus forming flocks as a result of the flocculation reaction of the flocculating agent.

5. A process for treating sludge according to any one of claims 1 to 4, wherein the flocks formed in the sludge treatment line are separated into a solid and liquid by a solid-liquid separator.

6. A process for treating sludge according to any one of claims 1 to 5, wherein the sludge flowing in the sludge treatment line downstream of the stirring pump is made a laminar flow to prevent destruction of the flocks formed in the sludge treatment line.

7. A process for treating sludge according to any one of claims 1 to 6, wherein the distance from the flocculating agent injection part to the stirring pump is set to a distance such that the flocculating agent can pass through in a reaction initiation time obtained in advance for each flocculating agent.

8. A process for treating sludge according to any one of claims 2 to 7, wherein either or both of the distances from the stirring pump to the flocculating agent injection part ahead thereof and the distance from the stirring pump to the solid-liquid separator is or are set to a distance or distances up to positions such that the flocculation strengths of flocks calculated based on the flocculation lasting periods of time of flocks formed after the stirring by the stirring pump are maximum.

9. A process for treating sludge, comprising the steps of: adding to sludge flowing in a sludge treatment line a flocculating agent for flocculating various materials such as dissolved solid, suspended solid or fine floating solid in the sludge in the midway of the sludge treatment line; and shear-stirring the flocculating agent-added sludge by a liquid shear-stirrer arranged in the midway of the sludge treatment line prior to initiation at flocculation reaction of the flocculating agent to disperse, diffuse or distribute the flocculating agent in a fine particulate state throughout the sludge in the sludge treatment line, thus forming aggregate structure type flocks as a result of the flocculation reaction of the flocculating agent.

10. A process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; shear-stirring the flocculating agent-added sludge by a liquid shear-stirrer arranged in the midway of sludge treatment line prior to initiation of flocculation reaction of the flocculating agent to disperse, diffuse or distribute the flocculating agent in a fine particulate state throughout the sludge in the sludge treatment line, and then adding to the sludge a second flocculating agent at a second flocculating agent injection part in the midway of the sludge treatment line to form aggregate structure type flocks as a result of the flocculation reaction of the flocculating agent.

11. A process for treating sludge, comprising the steps of: adding to sludge flowing in a sludge treatment line a first flocculating agent for flocculating various materials such as dissolved solid, suspended solid or fine floating solid in the sludge at a first flocculating agent injection part in the midway of the sludge treatment line; shear-stirring the flocculating agent-added sludge by a first liquid shear-stirrer arranged in the midway of sludge treatment line prior to initiation of flocculation reaction of the flocculating agent to disperse, diffuse or distribute the flocculating agent in a fine particulate state throughout the sludge in the sludge treatment line to form particle flocks by flocculation reaction; then adding to the sludge a second flocculating agent at a second flocculating agent injection part in the midway of the sludge treatment line; then shear-stirring the flocculating agent-added sludge by a second liquid shear-stirrer arranged in the midway of sludge treatment line prior to initiation of flocculation reaction of the flocculating agent such that the particle flocks thereof are not destructed to disperse, diffuse or distribute the flocculating agent in a fine particulate state throughout the sludge in the sludge treatment line to form aggregate structure type flocks as a result of the flocculation reaction of the flocculating agent; and allowing aggregate structure type flocks to gather at a subsequent laminar flow stage to grow into a sludge block.

12. A process for treating sludge, comprising the steps of: adding to sludge flowing in a sludge treatment line a flocculating agent for flocculating various materials such as dissolved solid, suspended solid or fine floating solid in the sludge at two or more flocculating agent injection parts in the midway of the sludge treatment line; and stirring the flocculating agent-added sludge by a liquid shear-stirrer or shear-stirrers arranged in the midway of sludge treatment line and ahead of arbitrary flocculating agent injection part or parts prior to initiation of flocculation reaction of the flocculating agent to disperse, diffuse or distribute the flocculating agent in a fine particulate state throughout the sludge in the sludge treatment line, thus forming flocks as a result of the flocculation reaction of the flocculating agent.

13. A process for treating sludge according to any one of claims 9 to 12, wherein the aggregate structure type flocks formed in the sludge treatment line are separated into a solid and liquid by a solid-liquid separator.

14. A process for treating sludge according to any one of claims 9 to 13, wherein the sludge flowing in the sludge treatment line downstream of the liquid shear-stirrer is made a laminar flow to prevent destruction of the aggregate structure type flocks formed in the sludge treatment line.

15. A process for treating sludge according to any one of claims 9 to 14, wherein the distance from the flocculating agent injection part to the liquid shear-stirrer is set to a distance such that the flocculating agent can pass through in a reaction initiation time obtained in advance for each flocculating agent.

16. A process for treating sludge according to any one of claims 9 to 15, wherein either or both of the distance from the first liquid shear-stirrer to the second flocculating agent injection part and the distance form the second flocculating agent injection part to the second liquid shear-stirrer is or are set to a distance or distances up to positions such that the flocculation strengths of flocks calculated based on the flocculation lasting periods of time of flocks formed after the shear-stirring by the second liquid shear-stirrer are maximum.
